(19) United States
(12) Patent Application Publication
(10) Pub. No.: US 2025/0155195 A1
(43) Pub. Date: May 15, 2025

(54) METHOD TO SUPPLY ELECTRIC POWER TO FURNACES FOR MELTING AND/OR HEATING METAL MATERIALS, AND CORRESPONDING APPARATUS

(71) Applicant: DANIELI AUTOMATION S.P.A., BUTTRIO (UD) (IT)

(72) Inventors: Antonello MORDEGLIA, BANGKOK (TH); Andrea POLO, SAN GIOVANNI AL NATISONE (UD) (IT); Federico PASUT, SAN VITO AL TAGLIAMENTO (PN) (IT); Mauro GUBANA, PULFERO (UD) (IT)

(21) Appl. No.: 18/838,358

(22) PCT Filed: Feb. 13, 2023
(86) PCT No.: PCT/IT2023/050043

§ 371 Date: Aug. 14, 2024

(30) Foreign Application Priority Data
Feb. 15, 2022 (IT) 102022000002756

(51) Int. Cl. F27B 3/28; F27B 3/08; H05B 7/144

(52) U.S. Cl. CPC F27B 3/28; F27B 3/085; H05B 7/144

(57) ABSTRACT

The invention concerns a method to supply electric power to furnaces (100) for melting and/or heating metal materials (M), which provides the supply of a mains voltage (Ur) and a mains current (Ir), both having a predefined mains frequency (fr); the transformation of said mains voltage (Ur) and mains current (Ir) into selectively settable alternating secondary voltage (Us) and secondary current (Is); the rectifying of said secondary voltage (Us) and secondary current (Is) and the conversion of the direct intermediate voltage (Ui) and intermediate current (Ii) into selectively settable alternating supply voltage (Ua) and supply current (Ia); the feeding of said supply voltage (Ua) and supply current (Ia) to a plurality of electrodes (102) of the furnace (100). The invention also concerns an apparatus (10) for supplying electric power to furnaces (100) for melting and/or heating metal materials (M).

### FIELD OF THE INVENTION

The present invention concerns a method to supply electric power to furnaces for melting and/or heating metal materials, and a corresponding apparatus for supplying electric power.

The present invention can be applied in the iron and steel production sectors, or also in sectors for working other metals, in which there are electric furnaces, for example electric arc furnaces, ladles, submerged arc furnaces, melting or refining furnaces, or suchlike.

### BACKGROUND OF THE INVENTION

Plants for heating and/or melting metal materials are known, comprising an electric furnace and one or more supply apparatuses connected to an electric power supply network.

Electric furnaces of the type in question can be selected from a group comprising: electric arc furnaces, submerged arc furnaces, ladle furnaces, and in general melting, refining, heating furnaces or suchlike.

By way of example, the melting cycle of an arc melting furnace includes the following operating steps:
loading the furnace with metal material, usually scrap, by means of baskets that unload from the top, or by means of continuous loading conveyor apparatuses fed with scrap and/or pre-reduced iron (DRI);
generating the electric arc, during which the electrodes are lowered toward the metal material until the melting electric arc is triggered, which is generated between the ends of the electrodes and the material to be melted;
boring the layer of metal material through the electric arc generated, during which the melting of the scrap begins;
forming the bath of molten metal;
refining the molten material to regulate the temperature of the bath and the carbon content of the steel and/or to define a desired composition of the steel by adding chemical components;
tapping the molten material present in the electric furnace, after possible slagging.

The step of refining the material can substantially correspond to what happens in the ladle furnace, used in the process downstream of tapping, to regulate the chemical composition of the steel definitively.

During the boring steps, the electric arc between the electrodes and the charge of metal material has a very unstable behavior, which progressively improves as melting progresses. This can cause quick and sudden variations in the power absorbed, which also negatively affect the electric power supply network, for example causing the so-called phenomenon of flickering, with possible damage to the user machines powered by the electric power supply network.

In fact, during boring and melting, the scrap amassed and not yet melted can collapse near the electrodes, generating short-circuit conditions which correspond to a considerable reduction in the active power needed for the melting operations and a rapid increase in the current absorbed by the electric network.

As melting progresses, that is, when the arc is suitably shielded by the solid material or by the foamy liquid (slag), the behavior of the electric arc becomes gradually more stable, thus allowing its length to be increased, and thus also increasing the heat power transferred to the material to be melted. The voltage and length of the arc are regulated according to the melting process also to prevent excessive wear on the refractory.

To limit the undesirable effects on the power supply network, it is known to carry out a rapid regulation of the power supplied to the furnace by means of a continuous regulation at least of the position of the electrodes and of the parameters of voltage and current imparted to the electrodes.

In particular, the parameters of voltage and current, as well as the position of the electrodes, are suitably regulated in each step of the process.

In such plants for heating and/or melting metal materials, the electric furnaces are usually powered by alternating current, of the three-phase type, supplied by the public electric network.

FIG. 1 schematically shows the reference values, or set point values, of the electrical parameters to be applied to the electrodes, as a three-basket melting cycle progresses, that is, one in which a first basket of metal material is loaded into the furnace, the metal material is melted, a second basket of metal material is loaded, the metal material is melted, and a third basket of metal material is loaded, with the melting and subsequent refining of all the liquid material obtained.

It can be noted that, in general, the electrical parameters of current I, voltage U and power P are made to vary, while the supply frequency f of the electrodes during the melting cycle remains constant and is generally equal to the mains frequency.

In general, melting and/or heating plants require a high supply power for the furnace; for example, the power supply required can be a few tens of megawatts (MW), in particular between 5 MW and 300 MW depending on the size of the plant and/or furnace.

As stated above, known power supply apparatuses have a disadvantage linked to the wide variation in instantaneous power absorption taken from the power supply network, which occurs in particular during boring due to the movements of the scrap which cause short circuits of the phases.

During boring, given the variability in power absorption by the furnace, fluctuations in the mains voltage are generated, causing the so-called phenomenon of flickering. Given that the melting process can vary greatly in terms of current fluctuation, and therefore of the voltage drop given the same frequency, it is important to try to keep the electric arc as stable as possible, in order to limit said flickering effect.

Documents WO 2019/207611 A1, WO 2021/111484 A1 and WO 2021/084566 A1 disclose known apparatuses and methods to supply electric power to furnaces. There is therefore a need to perfect a method to supply electric power to furnaces for melting and/or heating metal materials, in particular in alternating current, which can overcome at least one of the disadvantages of the state of the art.

In particular, one purpose of the present invention is to perfect a method, and to provide a corresponding apparatus, to supply electric power to furnaces for melting and/or heating metal materials, which increase the efficiency of the melting and/or heating process and reduce the power required by it.

It is also a purpose of the invention to perfect a method to supply electric power to furnaces for melting and/or heating metal materials which allows to reduce the melting time.

Another purpose is to provide an apparatus for supplying electric power to furnaces for melting and/or heating metal materials which is simple, economical and reliable, reducing disturbance phenomena to the electric power supply network such as the generation of harmonics and flickering.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, and to resolve the technical problem disclosed above in a new and original way, also achieving considerable advantages compared to the state of the prior art, a method to supply electric power to furnaces for melting and/or refining and/or heating metal materials according to the present invention comprises:
the supply of alternating mains voltage and current by means of electric power supply means, at a predefined mains frequency;
the transformation, by means of a transformer, of said mains voltage, current and frequency, into alternating secondary voltage, current and frequency having a selectively settable value, wherein the secondary frequency is substantially equal to the mains frequency;
the rectifying of the secondary voltage and current with a plurality of rectifiers to obtain a direct voltage and current;
the conversion, with a plurality of converters, of the direct voltage and current into an alternating supply voltage and supply current selectively settable by means of a control and command unit connected to the converters;
the feeding of the supply voltage and current to a plurality of electrodes of the furnace.

In accordance with one aspect of the present invention, the electric power supply method provides that, during each step of a work cycle of the furnace, regulation devices of the control and command unit regulate the supply frequency of the supply voltage and supply current in such a way that the supply frequency, for at least 80% of the duration of the work cycle, is lower than or equal to the mains frequency and, in at least one step of the work cycle, the supply frequency is comprised between 40% and 80% of the mains frequency.

In accordance with one aspect of the present invention, the electric power supply method provides that, during each step of a work cycle of the furnace, regulation devices of the control and command unit regulate the supply frequency of the supply voltage and supply current in such a way that the supply frequency for at least 80% of the duration of the work cycle is lower than the mains frequency.

According to preferred embodiments, the supply frequency of the supply voltage and current is lower than or equal to the mains frequency at least for 90% of the total duration of a work cycle.

According to other embodiments, the supply frequency of the supply voltage and current is lower than or equal to the mains frequency at least for 95% of the total duration of a work cycle.

According to other embodiments, the supply frequency is lower than the mains frequency for 100% of the total duration of a work cycle.

The possibility of adjusting the frequency to values lower than the mains frequency allows to reduce the losses induced on the conductors, for example caused by the skin effect, improving the passage of current inside the copper conductors so that the current passes through a greater part of the section of the conductors.

Furthermore, the use of a low-frequency current to power the electrodes allows to obtain an improvement in the stirring effect inside the molten bath, increasing the heat exchange, the uniformity of temperature inside the bath and therefore the efficiency of the system.

According to some embodiments, in at least one step of the work cycle, the supply frequency is greater than the mains frequency, for example comprised between 101% and 200% of the mains frequency.

The possibility of adjusting the supply frequency to values higher than the mains frequency allows to increase the stability of the electric arc, reducing the melting times of the metal material.

According to some embodiments, the supply frequency is kept above the mains frequency in conditions of instability of the power absorbed, that is, in conditions in which rapid oscillations of the power supply of the electric furnace occur, so as to counteract these oscillations and improve the melting process.

Doing so achieves at least the advantage of improving the transmission of energy in the molten material: with the same temperature gradient of the bath of metal material, the power consumption required by the electric furnace is therefore reduced.

It also follows that, for the execution of a casting, it is possible to use a lower current or, maintaining the same current, the melting execution times can be reduced, reducing power-on times.

According to preferred embodiments, in at least one step of the work cycle, the supply frequency is comprised between 1% and 80% of the mains frequency.

According to some embodiments, the method provides that, in at least one step of the work cycle, the supply frequency is comprised between 10% and 80% of the mains frequency.

According to some embodiments, the method provides that, in at least one step of the work cycle, the supply frequency is adjusted to a value comprised in the range between 1 and 45 Hz.

According to other embodiments, the method provides that, in at least one step of the work cycle, the supply frequency is adjusted to a frequency equal to about half the mains frequency.

According to some embodiments, the method provides that, in at least one step of the work cycle, the supply frequency is comprised between 101% and 200% of the mains frequency.

According to some embodiments, the method provides that, in at least one step of the work cycle, the supply frequency is adjusted to a value comprised in the range between 51 and 120 Hz.

The supply frequency can be adjusted dynamically during the work cycle, manually by an operator, or automatically in relation to instructions and procedures executed by a control unit.

According to some embodiments, the electric melting furnace is an electric arc furnace, and the work cycle comprises, in succession one to the other, a boring step, a melting step and a refining step, and the method provides to keep the supply frequency substantially equal to the mains frequency in the boring and melting steps and, at least in the refining step, to lower it until it is substantially halved.

According to other embodiments, the electric furnace is a ladle furnace, and the work cycle comprises at least one step of refining the molten metal material and the method provides to keep the supply frequency in a range comprised between 0.45 and 0.55 times the mains frequency for the entire work cycle.

Some embodiments of the present invention also concern an apparatus for supplying electric power to furnaces for melting and/or heating metal materials which comprises:
a transformer connected to power supply means that supply an alternating mains voltage and mains current, both having a predefined mains frequency, the transformer being configured to transform the mains voltage and the mains current respectively into an alternating secondary voltage and secondary current;
a plurality of rectifiers connected to the transformer and configured to transform the alternating secondary voltage and secondary current into direct electric voltage and current;
a plurality of converters connected to the rectifiers and configured to convert the direct electric voltage and current into alternating supply voltage and supply current, the converters being connected to electrodes of the furnace and to a control and command unit configured to control and command the functioning of the converters and regulate the alternating supply voltage and current over time.

In accordance with one aspect of the present invention, the control and command unit is provided with regulation devices configured to regulate, during each step of a melting cycle of the furnace, the electric power supply frequency of the alternating supply voltage and supply current, in such a way that for at least 80% of the duration of the work cycle the supply frequency is lower than or equal to the mains frequency, and in at least one of the steps of the work cycle in the furnace the supply frequency is comprised between 40% and 80% of the mains frequency.

Advantageously, the configuration of such apparatus allows to protect the electric power supply means from disturbances caused by the melting process (reduction of flicker, harmonics, and suchlike), while at the same time guaranteeing the stability of the arc in all steps.

According to some embodiments, the rectifiers and converters are disposed according to a modular type configuration. In this case, the electric power supply apparatus comprises a plurality of conversion modules, each of which contains at least one rectifier and one converter and is capable of supplying power from a minimum of 1 MW to a maximum of 30 MW.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a diagram that shows the variation over time of the electrical parameters applied to the electrodes of an arc furnace during a melting cycle in accordance with the state of the art;

FIG. 2 is a schematic view of an apparatus for supplying electric power to furnaces for melting and/or heating metal materials, according to the present invention;

FIGS. 3 and 4, 4(A), 4(B) are diagrams that show the variation over time of the electrical parameters applied to the electrodes of an arc furnace during a work cycle of a melting furnace, in accordance with some embodiments of the present invention;

FIG. 5 is a graph of the power trend in a work cycle of an arc furnace;

FIG. 6 is a diagram that shows the variation over time of the electrical parameters applied to the electrodes of a ladle furnace during a work cycle, in accordance with some embodiments of the present invention;

FIG. 7 is a diagram that shows the frequency variation of the power consumption of a ladle furnace.

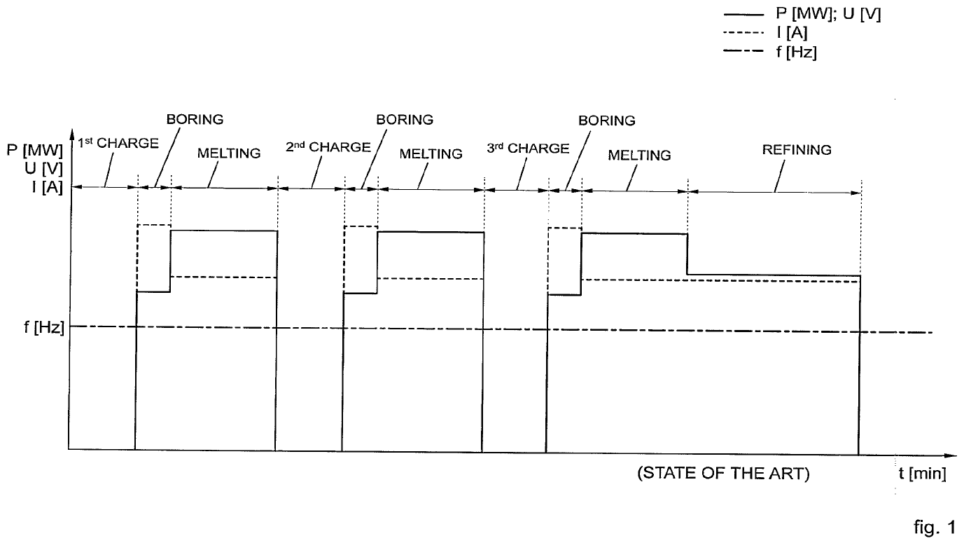

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

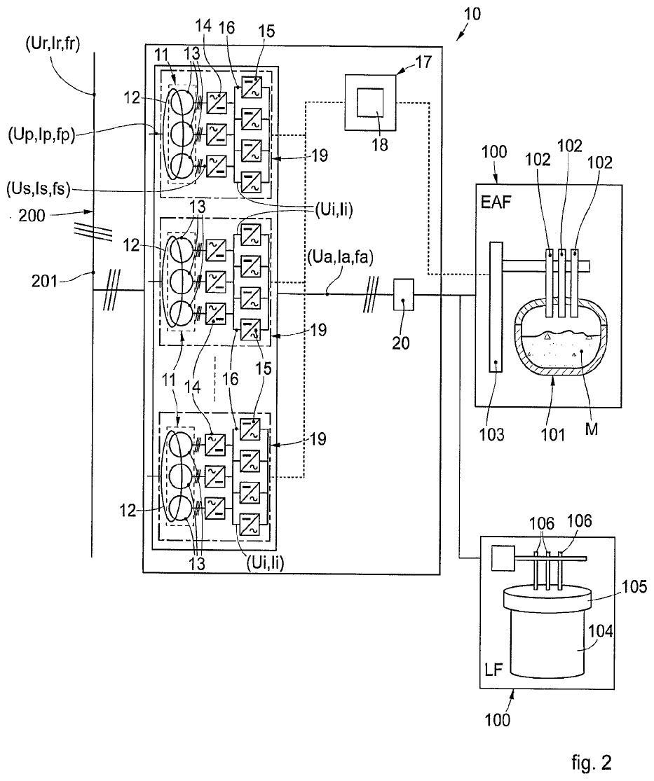

With reference to FIG. 2, some embodiments of the present invention concern an apparatus 10 for supplying electric power to furnaces 100 for melting and/or heating metal materials.

According to some embodiments, the apparatus 10 can be powered by electric power supply means 200. In the present description, we will refer, by way of example but not exhaustively, to a three-phase electric network 201.

The mains voltage Ur and the mains current Ir supplied by the network 201 can have a predefined mains frequency fr.

In accordance with possible solutions, the mains frequency fr is a value chosen between 50 Hz and 60 Hz, that is, according to the frequency of the electric network of the country in which the furnace 100 is installed.

According to some embodiments, the apparatus 10 can be configured to power loads of the three-phase type, in particular three-phase furnaces.

The furnace 100 of the type in question can be an electric arc furnace, a submerged arc electric furnace, a ladle furnace, or in general a melting or refining or heating furnace or suchlike, of the type suitable to be used in a steel mill for the production of steel, or in plants for working metal. Preferably, the invention is applicable to electric arc furnaces (EAF), ladle furnaces (LF) and smelters that use electrodes 102 to transfer thermal energy to the material to be treated.

FIG. 2 shows the apparatus 10 connected, by way of example, to an electric arc furnace EAF and to a ladle furnace LF. If both the arc furnace EAF as well as the ladle furnace LF are present in a steel plant, two apparatuses 10 can be provided, each connected to one of them, or a single apparatus 10 can be provided, suitable to suitably power each of the two furnaces EAF, LF.

In the case of a furnace 100 of the electric arc furnace EAF type, it comprises a container 101, or shell, into which metal material M to be melted is introduced.

The EAF furnace is also provided with a plurality of electrodes 102, in the case illustrated three electrodes 102, configured to strike an electric arc through the metal material M and melt it.

In the case of a ladle furnace LF, this generally comprises a ladle 104 suitable to contain the liquid metal tapped from the EAF furnace, a vault 105 which closes the ladle 104 at the top and a plurality of electrodes 106 disposed passing through the vault 105.

In the following description, we will refer mainly and by way of example to the EAF furnace.

According to some embodiments of the present invention, the electrodes 102, 106 are installed on movement devices 103 configured to selectively move the electrodes 102 toward or away from the metal material M or the metal bath in general.

The movement devices 103 can be chosen from a group comprising at least one of either a mechanical actuator, an electric actuator, a pneumatic actuator, a hydraulic actuator, an articulated mechanism, a mechanical kinematic motion, similar and comparable members or a possible combination of the above.

In accordance with one possible solution of the present invention, if the number of electrodes 102, 106 is three, each of them is connected to a respective power supply phase of the apparatus 10.

If there are more than three electrodes 102, 106, each power supply phase may be connected to two or more of them.

According to some embodiments, the apparatus 10 is able to receive energy supplied by the network 201 and transform it into supply voltage and current having certain electrical parameters Ua, Ia, fa suitable to power the furnace 100.

According to some embodiments, the apparatus 10 comprises at least one transformer 11 connected to the network 201 and configured to transform a primary alternating electric voltage Up and current Ip into a secondary alternating electric voltage Us and current Is.

In accordance with possible solutions, the transformer 11 can comprise a transformer primary 12 magnetically coupled to at least one transformer secondary 13.

This solution allows to reduce the impact of network-side disturbances, that is, to reduce the harmonic content and the reactive power exchanged with the network 201.

The secondary electrical energy supplied by the transformer 11 has a secondary voltage Us, a secondary current Is, and a secondary frequency fs, all predefined and set by the design characteristics of the transformer 11 itself.

According to some embodiments, the secondary frequency fs can be substantially equal to or lower than the mains frequency fr identified above or, in general, the primary frequency fp of the current circulating in the primary 12.

The secondary voltage Us and the secondary current Is can be correlated, respectively, to the mains voltage Ur and to the mains current Ir or, in general, to the primary voltage Up and to the primary current Ip of the primary 12, by the transformation ratio of the transformer 11 itself.

The transformer 11 can be provided with regulation devices, not shown, provided to selectively regulate its electrical transformation ratio in relation to specific requirements.

The apparatus 10 according to the present invention also comprises a plurality of rectifiers 14 connected to the transformer 11 and configured to transform the alternating secondary voltage Us and secondary current Is into direct intermediate voltage Ui and intermediate current Ii.

The rectifiers 14 can be chosen from a group comprising a diode bridge, a thyristor bridge, or other.

In accordance with one possible solution, the rectifiers 14 comprise devices, for example selected chosen a group comprising Diodes, SCR (Silicon Controlled Rectifier), GTO (Gate Turn-Off thyristor), IGCT (Integrated Gate-Commutated Thyristor), MCT (Metal-Oxide Semiconductor Controlled Thyristor), BJT (Bipolar Junction Transistor), MOSFET (Metal-Oxide Semiconductor Field-Effect Transistor) and IGBT (Insulated-Gate Bipolar Transistor).

According to some embodiments, the apparatus 10 comprises a plurality of converters 15 connected to the rectifiers 14 and configured to convert the direct voltage and current into an alternating supply voltage Ua and supply current Ia for the electrodes 102.

In accordance with one possible solution, the converters 15 comprise devices chosen, for example, from a group comprising SCR (Silicon Controlled Rectifier), GTO (Gate Turn-Off thyristor), IGCT (Integrated Gate-Commutated Thyristor), MCT (Metal-Oxide Semiconductor Controlled Thyristor), BJT (Bipolar Junction Transistor), MOSFET (Metal-Oxide Semiconductor Field-Effect Transistor), and IGBT (Insulated-Gate Bipolar Transistor).

In accordance with possible solutions, the rectifiers 14 can be connected to the converters 15 by means of at least one intermediate circuit 16 which works in direct current.

The intermediate circuit 16 can be configured to generate a separation between the rectifiers 14 and the converters 15 and, therefore, with the electric power supply means 200 connected upstream of the intermediate circuit 16 with respect to the furnace 100. In particular, the rapid power fluctuations deriving from the process are partly filtered through the intermediate circuit 16, reducing their impact on the side of the power supply means 200.

The intermediate circuit 16 can also be configured to store electrical energy continuously. According to some embodiments, the intermediate circuit 16 is a “DC link” and comprises at least one capacitor.

According to some embodiments, the apparatus 10 comprises a control and command unit 17, configured at least to control the converters 15 so as to selectively set the parameters of the supply voltage Ua and of the supply current Ia generated by the converters 15 and supplied to the electrodes 102.

Specifically, the supply voltage Ua and the supply current Ia can be selectively adjusted in relation to the work powers required; in the case of an EAF furnace, for example, in relation to the melting powers involved.

Furthermore, some embodiments of the present invention provide that the control and command unit 17 is also connected to the movement device 103 in order to allow an adjustment of the position of the electrodes 102 in relation to the various steps of the melting process. In particular, the electrodes 102 are moved by the movement device 103 to follow the position of the material and therefore modify the length of the arc.

In fact, during the melting step, the electric power supplied to the electrodes 102 can be increased compared to the boring step, given that the arc is now assumed to be covered and distant from the vault of the furnace, and therefore the risk of damaging the latter is avoided.

By means of the control and command unit 17, the supply voltage Ua and supply current Ia references can be modified so as to increase the active power. In this step, the arc is more stable, since it is protected by the scrap or slag.

Furthermore, during the refining step, the process is much more stable and also requires less power.

In this way, the control and command unit 17 can manage and command, in relation to the specific steps of the process, at least the following parameters: supply voltage Ua, supply current Ia, electric power supply frequency fa and position of the electrodes 102, 106. The high possibility of controlling the various parameters allows to optimize the transfer of energy to the process, and at the same time to reduce the effects on the network 201 deriving from the rapid variations in power on the furnace side.

Through the electrical topology adopted for the converters 15 it is also possible to preserve the network 201 from disturbances caused by the melting process (reduction of flicker, harmonics, Power Factor, etc.), while at the same time guaranteeing the stability of the arc in all the work steps of the furnace 100, both in the case of an EAF furnace and a ladle furnace LF.

The control and command unit 17 can comprise regulation devices 18.

In accordance with possible solutions of the present invention, the regulation devices 18 can comprise, by way of example only, a hysteresis modulator or a PWM (Pulse-Width-Modulation) modulator or suchlike.

These types of modulator can be used to command the semiconductor devices of the rectifiers 14 and converters 15: suitably controlled, they generate voltage or current values to be supplied to the furnace 100, in this specific case to the electrodes 102, 106. In particular, the modulator processes such voltage and current values and produces commands for driving at least the rectifiers 14 and the converters 15 so that the voltage and current quantities required by the control are present at the electrode 102, 106 connection terminals.

The voltages and currents to be actuated are the result of operations performed by the control and command unit on the basis of the quantities read from the process and on the basis of the process model.

According to the invention, the regulation devices 18 are configured to regulate, during each step of a melting cycle of the furnace 100, the electric power supply frequency fa of the supply voltage Ua and supply current Ia.

The regulation devices 18 are commanded by the control and command unit 17.

In particular, the regulation devices 18 are commanded by the control and command unit 17 so that the supply frequency fa is lower than or equal to the mains frequency fr at least for 80% of the total duration of a work cycle.

According to some embodiments, in at least one step of the work cycle, the supply frequency fa is comprised between 0.5% and 200% of the mains frequency fr.

According to some embodiments, the supply frequency fa is always lower than or equal to the mains frequency fr, right from the beginning of the work cycle and, moreover, at least in one of the steps of the work cycle in the furnace 100, the supply frequency fa is lower than the mains frequency fr of the power supply means 200, in particular comprised between 40% and 80% of the mains frequency fr.

According to some embodiments, in general, the supply frequency fa can be, at least in one step of the work cycle in the furnace 100, lower than the primary frequency fp of the current circulating in the primary 12 of the transformer 11.

According to possible solutions, the rectifiers 14 and the converters 15 are connected according to a modular configuration, defining as a whole a power supply module 19.

According to some embodiments, the apparatus 10 comprises a plurality of power supply modules 19, each of which contains at least one rectifier 14 and a converter 15 and is capable of supplying power from a minimum of 1 MW to a maximum of 30 MW.

According to some embodiments, each power supply module 19 also comprises at least one intermediate circuit 16, or DC-link, connected between the at least one rectifier 14 and the at least one converter 15.

According to possible embodiments, each power supply module 19 comprises at least one rectifier 14, a DC-link 16 and a converter 15 for each phase of the three-phase network 201.

Preferably, all the power supply modules 19 can be of the same size, that is, they can supply the same range of electric power.

Normally, the preferred sizing ranges of each of the power supply modules 19 vary from 5 to 20 MW.

In a preferential embodiment, all the power supply modules 19 are of the same size, for example all of 10 MW, all of 20 MW, etc.

According to some embodiments, each power supply module 19 also comprises a transformer 11.

In the event that the or each module 19 has respective rectifiers 14, intermediate circuits 16 and converters 15 for each phase of the network 201, the transformer 11 may comprise a single transformer primary 12 and a plurality of transformer secondaries 13, wherein each transformer secondary 13 is connected to a rectifier 14.

According to some embodiments, the apparatus 10 can be provided with a plurality of power supply modules 19, connected in parallel to each other, to the network 201 and to the furnace 100.

The combination of several power supply modules 19 allows to obtain an apparatus 10 which can be scaled in size in relation to the specific size of the furnace 100 that has to be powered.

In accordance with one possible solution, the control and command unit 17 is connected to all the power supply modules 19 in order to control at least the respective converters 15 so that each module 19 supplies the same values of supply voltage Ua, supply current Ia and supply frequency fa to the electrodes 102. In this way, it is possible to prevent malfunctions of the entire system.

According to other variants, it can also be provided that the power supply modules 19 can be controlled in such a way as to supply different respective values of supply voltage Ua, supply current Ia, and supply frequency fa to each electrode 102, for example in order to vary the distribution of power within the melting bath.

In accordance with one possible solution, the apparatus 10 can comprise an inductor 20 configured to achieve the desired overall reactance of the apparatus.

The inductor 20 can be connected downstream of the converters 15 and is sized so as to reach the desired total equivalent reactance. In this way, it is possible to obtain an overall reactance which is given by the contribution of the inductor 20 and by the reactance introduced by the conductors which connect the apparatus 10 to the furnace 100, or in this specific case to the electrodes 102.

In general, the inductance is a (design) parameter that cannot be modified once the component has been built.

By modifying the frequency (with respect to, for example, the 50 Hz or 60 Hz of the network) it is possible, with the same inductance, to change the reactance value assumed by the component in the circuit and therefore reach the desired total equivalent reactance value.

The functioning of the apparatus 10 for supplying electric power to furnaces for melting and/or heating metal materials M described heretofore, which corresponds to the method according to the present invention, provides:
the supply, by means of electric power supply means 200, of an alternating mains voltage Ur and mains current Ir having a predefined mains frequency fr;
the transformation, by means of a transformer 11, of the alternating mains voltage Ur and mains current Ir into an alternating secondary voltage Us and secondary current Is which are selectively settable and have a secondary frequency fs substantially equal to the mains frequency fr;
the rectifying of the secondary voltage Us and secondary current Is with a plurality of rectifiers 14 to obtain a direct current intermediate voltage Ui and intermediate current Ii;
the conversion, with a plurality of converters 15, of the direct current intermediate voltage Ui and intermediate current Ii into an alternating supply voltage Ua and supply current Ia which are selectively settable by means of a control and command unit 17 connected to the converters 15;
the feeding of the supply voltage Ua and supply current Ia to a plurality of electrodes 102 of the furnace 100.

The method provides that, during each step of a work cycle of the furnace 100, regulation devices 18 of the control and command unit 17 regulate the supply frequency fa of the supply voltage Ua and supply current Ia in such a way that the supply frequency fa is lower than or equal to the mains frequency fr at least for 80% of the duration of a work cycle and, at least in one step of the work cycle in the furnace 100, it is lower than the mains frequency fr, preferably comprised between 40% and 80% of the mains frequency fr.

According to preferred embodiments, the supply frequency fa is lower than or equal to the mains frequency fr at least for 90% of the total duration of a work cycle.

According to other embodiments, the supply frequency fa is lower than or equal to the mains frequency fr at least for 95% of the total duration of a work cycle. According to preferred embodiments, the supply frequency fa is lower to the mains frequency fr at least for 90% of the total duration of a work cycle, preferably at least for 95% of the total duration.

According to some embodiments, the method provides that, in at least one step of the work cycle, the supply frequency is comprised between 10% and 80% of the mains frequency.

According to some embodiments, the method provides that, in at least one step of the work cycle, the supply frequency fa is comprised between 45% and 75% of the mains frequency fr.

According to some embodiments, the method provides that, in at least one step of the work cycle, the supply frequency fa is comprised between 101% and 200% of the mains frequency fr.

According to some embodiments, the method provides that, in at least one step of the work cycle, the supply frequency fa is adjusted to a value comprised in the range between 55 and 120 Hz.

The supply frequency fa can be adjusted dynamically during the work cycle, manually by an operator, or automatically in relation to instructions and procedures performed by the control and command unit 17.

In the present description, by work cycle we mean the set of work steps provided for a certain furnace 100.

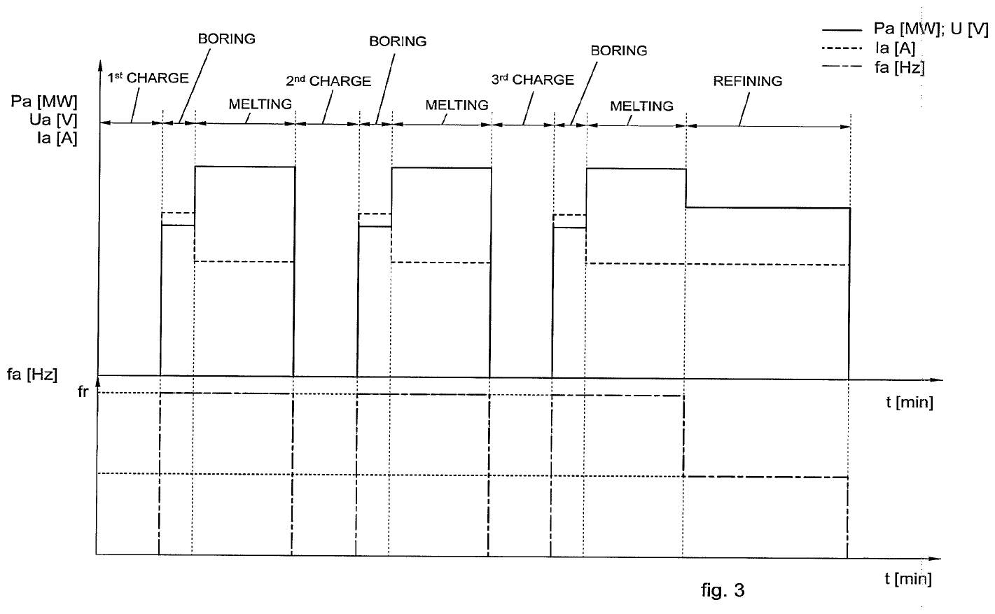

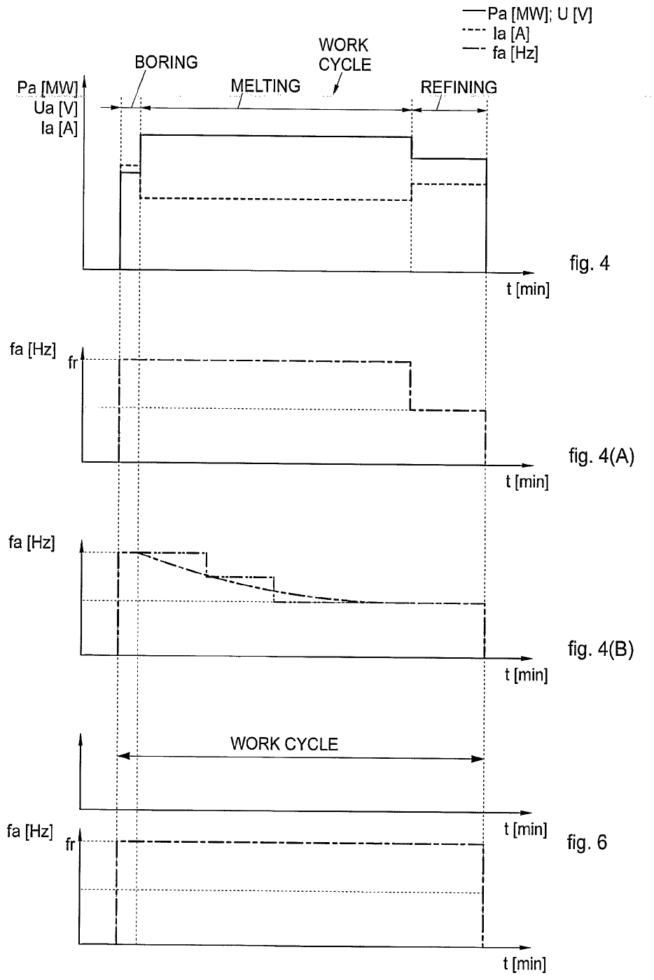

For example, and as shown in FIGS. 3 and 4, 4(A) and 4(B), for an arc furnace EAF the work cycle can comprise at least a step of boring the metal material M, a step of melting and possibly a step of refining the melted material.

In particular, during the boring step the electrodes 102 are brought close to the discharged solid metal material M, in order to strike the electric arc and start the melting of the metal material M. As the metal material M gradually melts, the electrodes 102 penetrate the part of the metal material M that is still solid, in order to gradually melt it. When the electrodes 102 reach a position inside the container 101, the actual melting of the remaining metal material M surrounding the electrodes 102 begins.

In accordance with one possible solution (FIG. 3), the boring step and the melting step can be repeated several times before the refining step, and between them there is provided a step of loading additional metal material M into the electric furnace 100.

For example, with reference to FIG. 3, it is provided to load a charge of the metal material M, to bore the metal charge with the electrodes 102 and to melt it. This operating sequence is repeated three times, each time the metal material M is loaded.

In accordance with the solutions shown in FIGS. 4, 4(A) and 4(B), a substantially continuous charge is provided which is started before the boring step and continues until the furnace is completely filled and during the step of melting the metal material.

According to this embodiment, the supply frequency fa is lower than or equal to the mains frequency fr for the entire duration, that is, 100%, of the work cycle. According to some embodiments, the method can provide that the supply frequency fa decreases with the progress of the work cycle of the furnace 100 over time.

The supply frequency fa can be decreasing starting from a pre-set value, such as the value of the mains frequency fr or the primary frequency fp on the primary 12 of the transformer 11; preferably, it is decreasing starting from the value of the mains frequency fr.

The supply frequency fa can be decreasing continuously over time, for example decreasing linearly or exponentially or suchlike, as represented by the dash-dot line in FIG. 4(B).

The supply frequency fa can be decreasing over time in a discontinuous manner, for example with a step-like trend, as represented by the dash-double dot line in FIG. 4(B). The supply frequency fa can therefore assume a plurality of values f1 which are lower than the mains frequency fr.

The method can also provide that the supply frequency fa is substantially constant at least during the time corresponding to each work step of the furnace 100.

The method can provide that the supply frequency fa, at the end of the work cycle in the furnace 100, reaches a value at least 20% lower, preferably at least 40%, than the mains frequency fr, even more preferably it is substantially halved compared to the mains frequency fr.

The method can provide that the supply frequency fa assumes, at least in one or more work steps of the furnace 100, a value substantially comprised between 30 and 40 Hz.

For example, with reference to an EAF furnace, the supply frequency fa can be substantially equal to the mains frequency fr in the boring step, and it can be comprised between 0.45 and 0.55 times the mains frequency fr in the refining step.

The method can provide that, in an EAF furnace, the supply frequency fa is substantially equal to the mains frequency fr during the boring step and decreasing in the subsequent work steps, until it assumes a value f1, for example substantially equivalent to half the value of the mains frequency fr (FIG. 3).

According to another example and as shown in FIG. 4(A), the method can provide that, in an EAF furnace, the supply frequency fa is substantially equal to the mains frequency fr during the boring step and the step of melting the charge, and decreasing with a step-like trend in the subsequent work steps.

According to some embodiments, not illustrated, it can be also provided that the supply frequency fa is lower than the mains frequency fr in all the work steps.

According to some variants, the method provides that, in at least one step of the work cycle, the supply frequency fa is higher than the mains frequency fr, for example comprised between 101% and 200% of the mains frequency fr.

According to some embodiments, the method provides that, in at least one step of the work cycle, the supply frequency is adjusted to a value comprised in the range between 51 and 100 Hz, or between 61 and 120 Hz, depending on the value of the mains frequency.

According to some embodiments, the supply frequency fa is adjusted so as to be higher than the mains frequency fr at least in situations where there are rapid oscillations of the power absorbed by the EAF furnace, for example in correspondence with the charge of metal material.

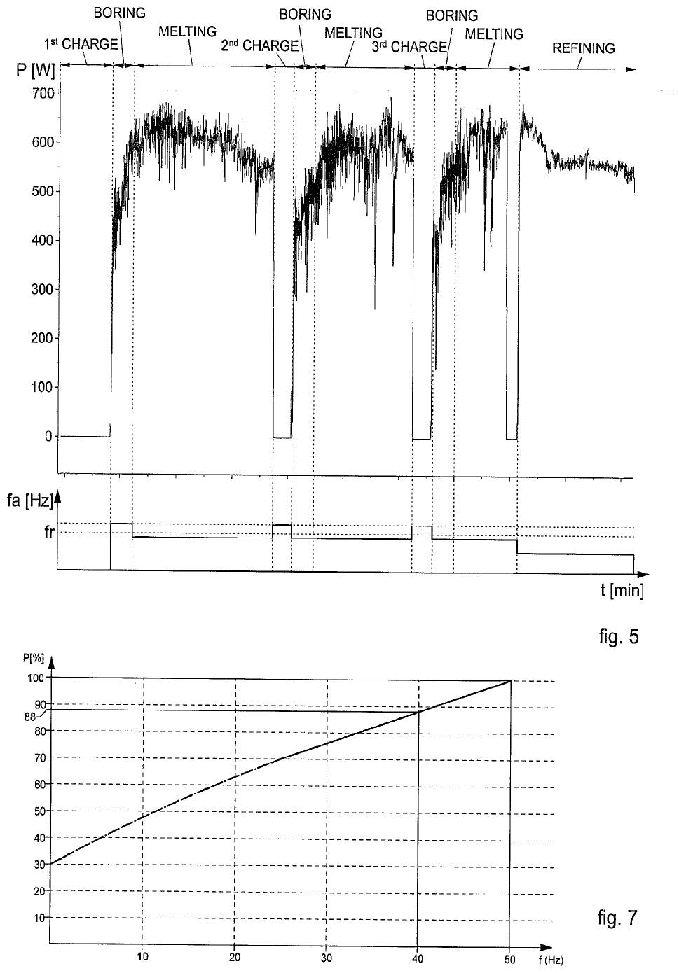

For example, FIG. 5 shows a graph which in the upper part illustrates the trend of the electric power absorbed by the charge during a work cycle, and in the lower part it illustrates how the supply frequency fa is adjusted with respect to the mains frequency fr.

The parts highlighted with closed lines indicate situations in which rapid oscillations and variations of power occur: as can be seen, in correspondence with these situations the supply frequency fa is higher than the mains frequency fr, while for the remaining duration of the work cycle it is lower than or equal to the mains frequency fr.

Therefore, with the present invention, once the work points of the furnace 100 have been established, at least in terms of power, voltage, current and frequency, the method can provide that the control and command unit 17 tries to follow these work points, also through the continuous adjustment of the supply frequency fa.

The work points may be determined by an operator, or may also be determined automatically by the control and command unit 17, e.g. based on a mathematical model of the furnace 100 and/or a given melting and/or heating process, or even calculated on the basis of input data received in relation to the type of material to be melted, the end product to be obtained, the characteristics of the furnace 100, the required hourly output or other factors.

With the present invention it is therefore possible, by adjusting the frequency during the various steps of the process, to optimize the electrical parameters in each step.

As another example, for example described with reference to FIG. 6, in a ladle furnace LF, the work cycle comprises at least one step of refining the molten metal material M.

According to possible embodiments, the method can provide that in the ladle furnace LF the supply frequency fa remains constant for the entire duration of the work cycle, or that the supply frequency fa decreases over time, linearly, in steps, exponentially, or according to other mathematical curves, and possibly even with a combination thereof.

In any case, in the ladle furnace LF the supply frequency fa preferably remains lower than the mains frequency fr for the entire duration of the work cycle.

For example, according to the embodiment described with reference to FIG. 6, the method can provide that, in the ladle furnace LF, the supply frequency fa is constant for the entire work cycle and assumes a value lower than the mains frequency fr, preferably a value comprised between 0.4 and 0.6 times the mains frequency fr.

Preferably, the supply frequency fa in the ladle furnace LF is substantially equal to half the value of the mains frequency fr, until the end of the refining step.

Advantageously, and as shown in FIG. 7, in the example case of an LF furnace, with the temperature gradient obtained being equal, the present invention allows to reduce the power consumption required by the furnace 100: for example, with the other work conditions being equal, in an LF furnace at a work frequency of 40 Hz it is possible to obtain a reduction of the power consumed substantially of 12% compared to the power required at the frequency of 50 Hz.

As another advantage and by way of example, in a work cycle at a work frequency of 40 Hz, the power factor can be increased, other conditions being equal, from 0.90 to 0.96.

As another advantage, thanks to an increase in the arc power obtainable by reducing the work frequency, the melting time can be reduced.

By way of example, in an arc furnace EAF, the reduction in melting time can be of approximately 20% at a frequency of 25 Hz and 35% at a frequency of 10 Hz. As another example, in an LF furnace, at a work frequency of 40 Hz, the power-on time can be reduced by an average of about 20-22 minutes.

Advantageously, it is also possible to reduce the consumption of the electrodes 102, 106: for example, at a work frequency of 40 Hz, the consumption of the electrodes 102, 106 can be reduced by approximately 10%.

It is clear that modifications and/or additions of parts may be made to the apparatus 10 and to the method as described heretofore, without departing from the field and scope of the present invention, as defined by the claims.

It is also clear that, although the present invention has been described with reference to some specific examples, a person of skill in the art shall certainly be able to achieve many other equivalent forms of method and apparatus 10 for supplying electric power to furnaces for melting and/or heating metal materials, having the characteristics as set forth in the claims and hence all coming within the field of protection defined thereby.

In the following claims, the sole purpose of the references in brackets is to facilitate their reading and they must not be considered as restrictive factors with regard to the field of protection defined by the same claims.

1. Method to supply electric power to furnaces for melting and/or heating metal materials which provides:
the supply, by means of electric power supply means, of an alternating mains voltage and mains current both having a predefined mains frequency;
the transformation, by means of a transformer, of said mains voltage and mains current into an alternating secondary voltage and secondary current, selectively settable and having a secondary frequency substantially equal to said mains frequency;
the rectifying of said secondary voltage and secondary current with a plurality of rectifiers to obtain a direct current intermediate voltage and intermediate current;
the conversion, with a plurality of converters, of said direct current intermediate voltage and intermediate current into an alternating supply voltage and supply current, selectively settable by means of a control and command unit connected to said converters;
the feeding of said supply voltage and supply current to a plurality of electrodes of the furnace, said method wherein during each step of a work cycle of said furnace, regulation devices of said control and command unit regulate the supply frequency of said supply voltage and supply current in such a way that the supply frequency for at least 80% of the duration of said work cycle is lower than or equal to said mains frequency, wherein at least in one step of said work cycle of said furnace the electric power supply frequency is comprised between 40% and 80% of the mains frequency.

2. Method to supply electric power to furnaces for melting and/or heating metal materials which provides:
the supply, by means of electric power supply means, of an alternating mains voltage and mains current both having a predefined mains frequency;
the transformation, by means of a transformer, of said mains voltage and mains current into an alternating secondary voltage and secondary current, selectively settable and having a secondary frequency substantially equal to said mains frequency;
the rectifying of said secondary voltage and secondary current with a plurality of rectifiers to obtain a direct current intermediate voltage and intermediate current;
the conversion, with a plurality of converters, of said direct current intermediate voltage and intermediate current into an alternating supply voltage and supply current, selectively settable by means of a control and command unit connected to said converters;
the feeding of said supply voltage and supply current to a plurality of electrodes of the furnace, said method wherein during each step of a work cycle of said furnace, regulation devices of said control and command unit regulate the supply frequency of said supply voltage and supply current in such a way that the supply frequency for at least 80% of the duration of said work cycle is lower than said mains frequency.

3. Method as in claim 1, wherein said supply frequency is lower than said mains frequency at least for 90% of the total duration of a work cycle.

4. Method as in claim 1, wherein said supply frequency is lower than said mains frequency at least for 95% of the total duration of a work cycle.

5. Method as in claim 1, wherein said supply frequency is lower than said mains frequency for 100% of the total duration of a work cycle.

6. Method as in claim 1, wherein at least one step of the work cycle, said supply frequency (fa) is higher than said mains frequency (fr) and is comprised between 101% and 200% of said mains frequency (fr).

7. Method as in claim 1, wherein said supply frequency decreases continuously or with a step-like trend starting from the value of said mains frequency during the work cycle in said furnace, and in that, at the end of the work cycle in said furnace, it reaches a value at least 20% lower than the mains frequency.

8. Method as in claim 1, wherein said furnace is an electric arc furnace and said work cycle comprises at least one step of boring the metal material, a melting step and a step of refining the molten material, and in that said supply frequency is substantially equal to said mains frequency at least during the step of melting the charge and it decreases in the subsequent work steps of said electric arc furnace.

9. Method as in claim 1, wherein said supply frequency is greater than said mains frequency during said boring step and/or in the conditions in which rapid oscillations of the power supply of said electric arc furnace occur.

10. Method as in claim 1, wherein said supply frequency is substantially constant in each work step of said furnace and it is at least 20% lower than said mains frequency.

11. Method as in claim 10, wherein said furnace is a ladle furnace and said work cycle comprises at least one step of refining the molten material and in that said supply frequency is constant and it assumes a value lower than the mains frequency during the entire refining step in said ladle furnace.

12. Method as in claim 10, wherein said furnace is a ladle furnace and said supply frequency is constant during the entire work cycle and it assumes a value comprised between 0.4 and 0.6 times said mains frequency.

13. Method as in claim 1, wherein said supply frequency assumes, at least in one step of said work cycle in said furnace, a value comprised between 30 and 40 Hz.

14. Method as in claim 1, wherein it provides to establish work points of said furnace, at least in terms of power, voltage, current and frequency to be supplied to said electrodes and said control and command unit commands at least said regulation devices in order to try to follow said work points, also through the continuous adjustment of said supply frequency.

15. Apparatus for supplying electric power to furnaces for melting and/or heating metal materials which comprises:
a transformer connected to power supply means that supply an alternating mains voltage and mains current, both having a predefined mains frequency, said transformer being configured to transform said alternating mains voltage and mains current respectively into an alternating secondary voltage and secondary current;
a plurality of rectifiers connected to the transformer and configured to transform said alternating secondary voltage and secondary current into direct current voltage and electric current;
a plurality of converters connected to said rectifiers and configured to convert said direct current voltage and current into alternating supply voltage and supply current, said converters being connected to electrodes of said furnace, and
a control and command unit configured to control and command the functioning of said converters and to regulate said supply voltage and supply current over time, wherein said control and command unit is provided with regulation devices configured to regulate, during each step of a melting cycle of said furnace, the electric power supply frequency of said supply voltage and supply current, in such a way that for at least 80% of the duration of said work cycle the supply frequency is lower than or equal to said mains frequency, wherein in at least one step of said work cycle in said furnace the supply frequency is comprised between 40% and 80% of said mains frequency.

16. Apparatus for supplying electric power to furnaces for melting and/or heating metal materials which comprises:
a transformer connected to power supply means that supply an alternating mains voltage and mains current, both having a predefined mains frequency, said transformer being configured to transform said alternating mains voltage and mains current respectively into an alternating secondary voltage and secondary current;
a plurality of rectifiers connected to the transformer and configured to transform said alternating secondary voltage and secondary current into direct current voltage and electric current;
a plurality of converters connected to said rectifiers and configured to convert said direct current voltage and current into alternating supply voltage and supply current, said converters being connected to electrodes of said furnace, and
a control and command unit configured to control and command the functioning of said converters and to regulate said supply voltage and supply current over time, wherein said control and command unit is provided with regulation devices configured to regulate, during each step of a melting cycle of said furnace, the electric power supply frequency of said supply voltage and supply current, in such a way that for at least 80% of the duration of said work cycle the supply frequency is lower than said mains frequency.

17. Apparatus as in claim 15, wherein said regulation devices are selected from hysteresis modulators or PWM modulators.

18. Apparatus as in claim 15, wherein it comprises a plurality of power supply modules each containing at least one rectifier and a converter, wherein said plurality of power supply modules are connected in parallel to each other to said power supply means and said furnace, and in that said control and command unit is connected to all the power supply modules in order to control at least the respective converters in such a way that each supply supplies the same values of supply voltage, supply current, and electric supply frequency to said electrodes.

19. Apparatus as in claim 15, wherein it comprises at least one intermediate circuit which connects said rectifiers to said converters and works in direct current, wherein said intermediate circuit is configured to store electrical energy continuously and generate a separation between the converters and the rectifiers and, therefore, with said power supply means.
